(19) United States
(12) Patent Application Publication
(10) Pub. No.: US 2009/0119378 A1
(43) Pub. Date: May 7, 2009

(54) CONTROLLING ACCESS TO AN R-SMART NETWORK

(75) Inventor: Thomas W. Lynch, Galveston, TX (US)

Correspondence Address: AMIN, TUROCY & CALVIN, LLP, 127 Public Square, 57th Floor, Key Tower, CLEVELAND, OH, 44114, US

(73) Assignee: LIANG HOLDINGS LLC, Wilmington, DE (US)

(21) Appl. No.: 11/936,716

(22) Filed: Nov. 7, 2007

(51) Int. Cl. G06F 15/16

(52) U.S. Cl. 709/206; 709/204

(57) ABSTRACT

Implementations related to controlling access to r-smart person-centric networks are disclosed.

### BACKGROUND

Communication is an increasingly important component of most people's lives and the average person may make contact with hundreds of other people. There is an increasing trend in the number of contacts, and this has created new challenges for managing contacts.

Some social scientists maintain that most communication is emotional and that analytical content is secondary, if present at all. Whether justified or not, caring and emotions are frequently termed “right brain” activities, and hence being good at these activities is sometimes referred to as ‘r-smartness’ which is short for ‘right brain smartness’.

People often use r-smartness in determining how they communicate with other people. In some cultures this may be very pronounced, and may even affect the vocabulary and grammar of a conversation. For example, in pre-modern Europe, third person and indirect terms were used when conversing with royalty. As another example, in Japan different forms of address are used depending on whether one is speaking to children, family, co-workers, elders and bosses. Take for instance the Japanese word for thank you. It may take the form of “domo”, “domo arigato”, and “domo arigato gozaimasu” depending on the perceived acting role and status difference in the conversation. Thus, in this context, acting roles may include such things as parent-child, student-teacher, employee-boss, among others. Furthermore, status differences may be based on age, attainment in a skill, spiritual attainment, money, among others. Indeed, this also exists in a less formal form in American English with “thanks”, “thank you”, and “thank you very much” and other variations said in different tones and intonations. However, r-smartness comes into play in a variety of situations, not just when saying thank you.

As telecommunication means have diversified from simple land-line phones to include, among others, PDAs (personal digital assistants), cell phones, email devices such as desktop computers and laptops, and the like, the use of simple phone books and operator assistance may no longer be optimum means for keeping track of contacts. As a result, personally owned contacts lists are playing a larger role in people's lives. Enhancing such personally owned contacts lists may result in smother communications and enhanced productivity. Moreover, providing schemes for controlling access to and/or use of personally owned contacts lists may be desirable.

### BRIEF DESCRIPTION OF THE DRAWINGS

Subject matter is particularly pointed out and distinctly claimed in the concluding portion of the specification. Claimed subject matter, however, both as to organization and method of operation, together with objects and features thereof, may best be understood by reference of the following detailed description if read with they accompanying drawings in which:

FIG. 1 illustrates an example method; and

FIG. 2 illustrates an example system.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the following detailed description are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical, magnetic and/or electromagnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

While claimed subject matter is not limited to specific types of communications technology, to particular technological contexts employing groupings of personal contacts, nor to particular characteristics describing personal contact groupings, in some implementations, claimed subject matter may be illustrated in the context of r-smart networks employing relationship ring contact lists.

As used throughout this disclosure and in the claims that follow, the phrase “relationship ring” may be used to describe a group of personal contacts (e.g., a list of contacts) sharing one or more emotient attributes in common. Claimed subject matter is not limited in this regard however, and, thus, a grouping of personal contacts in accordance with claimed subject matter may be described as a “ring”, a “list”, a “group” or “grouping”, a “domain”, to name just a few examples. Thus, within this disclosure, use of terms such as “ring” should not be understood as describing a literal geometric shape, even though such shapes may be employed in network diagrams, etc., that may be used to illustrate example implementations of claimed subject matter.

Further, in this disclosure, and the claims that follow, the phrase “r-smart network” may refer to a grouping of personal contacts having emotient attributes in common where the phrase “emotient attributes” may refer to properties of familiarity, affection, respect, esteem, status, acting role of entities, etc. and may be defined with respect to a user of a communications client. In other words, emotient attributes may reflect how a user feels about personal contacts in a grouping of personal contacts.

In some implementations of claimed subject matter communicative access to a relationship ring may be controlled by a relationship “passport” or “visa”. In the context of claimed subject matter, the terms passport and visa may refer to an electronic document used to pass or convey trust between members of relationship rings, and new would-be members. Thus, in accordance with claimed subject matter, receipt and acceptance of such a passport by a user may provide a new member with communicative access to one or more of the user's relationship ring contact lists. In other words, in accordance with claimed subject matter, a user may be introduced to a prospective personal contact by, for example, a trusted personal contact, and may grant the prospective personal contact communicative access to a least part of the user's contact list. In this disclosure and/or in the claims that follow the terms communication and message may be used interchangeably to signify conveyance of information between parties (e.g., between a user and a prospective personal contact). For example, as discussed further below, a message may comprise an email communication from one party to another where that email is generated in response to and/or includes a passport or a related document.

In some implementations of claimed subject matter, contacts or “members” belonging to a “blessed” relationship ring may, in a ring trust transaction, introduce new members to certain other relationship rings. Three parties may be involved in such a trust transaction: a user, an agent, and a pledge. In this context, a pledge may be defined as a person or entity that desires to contact a user, an agent may be defined as a person or entity that facilitates the contact, and a user may be defined as the person or entity to be contacted. When used in this description and/or the claims that follow, the terms “person” or “people” may refer to an agent, a pledge, a user, a user's relationship ring account and/or a user's machine and/or machines that facilitate the account. In some implementations of claimed subject matter a user and an agent may be the same person. Further, in some implementations of claimed subject matter, the various roles may comprise different people or may comprise the same people.

In some implementations of claimed subject matter the role of agent may be restricted to certain persons. Thus, for example, a property, agent_enabled, may be defined and may be attached to relationship rings or to individual contacts. Likewise, a countermanding property may be defined so that a user may revoke or remove an agent_enabled property from contacts that may otherwise attain the property by virtue of membership in a particular relationship ring.

In some implementations of claimed subject matter, a particular relationship ring may be associated with the agent_enabled property so that all members of that ring inherit the agent_enabled property. Thus, for example, such a ring could be termed a “trusted” relationship ring. A member of a trust ring may comprise an enabled agent who may then introduce a potential new member or pledge to a user by sending out two documents: a passport document conveyed to the pledge, and a receipt associated with the passport conveyed to the user.

In some implementations of claimed subject matter, a user's communications client may or may not show a passport receipt to the user, but may internally acknowledge receipt of the passport. In some implementations of claimed subject matter, a passport receipt may comprise a human comprehensible introductory note sent to a user by an agent. In some implementations of claimed subject matter, alternatives associated with display, form, and/or management of passport receipts may be set as a user preference.

In some implementations of claimed subject matter, a passport receipt may generate an entry in a user's contact list for the introduced pledge. In some implementations, such as entry may be displayed in a graphical user interface (GUI). Further, display of an entry may be delayed until communication (e.g., email) is actually received from a pledge, and/or in other implementations, an entry may be displayed in a special area, and/or may be faint or otherwise deemphasized until the pledge is accepted by the user. For example, such a special area in a GUI used for this purpose may be referred to as a “probationary” area. In some implementations of claimed subject matter, entries appearing in a GUI's probationary area may expire after a period of time, and may then be no longer displayed on the GUI.

In some implementations of claimed subject matter a passport and/or a passport receipt may be generated by a passport manager that comprises a component, for example, of a relationship rings enhanced communications client such as an email client. In some implementations, an agent may be able to manually create a passport and/or a passport receipt in the body of a communication such as an email.

In some implementations, a passport may be temporary and may be configured to expire after a period of time. In accordance with claimed subject matter, a passport may expire after it has been used a number of times. In some implementations a passport may be re-issued after it expires. In some implementations a passport may expire if one or more events do not occur within a certain time. For example, a user, using, for example, a passport manager, may set a passport preference that specifies how many times a passport may be used. In this context, providing a passport to a pledge may convey a temporary privilege to a pledge allowing the pledge to communicate with a user. This privilege may then be revoked or expire when the passport expires.

Alternatively, a user may specify a passport life span or term so that once a passport is generated and/or provided to a pledge certain event or events need to occur within that term or the passport will expire. Events that may need to occur to prevent a passport from expiring include, but are not limited to, a pledge receiving a passport, a pledge acting on a passport by sending a communication to a user, a user accepting and/or registering a passport receipt or a communication received from a pledge, and/or a user accepting a pledge.

In some implementations of claimed subject matter a passport may include an agent's identifier, a relationship ring name and/or a role associated with the agent. Further, in some implementations of claimed subject matter, a pledge may include an agent's identifier, a relationship ring name and/or a role associated with the agent in a message sent to a user. If an agent's identifier, a relationship ring name and/or a role associated with the agent are not present in a message sent from a pledge to a user then, in some implementations of claimed subject matter, the message may be associated with a “nobody” ring or may bounce, depending, for example, on user preference settings. In some implementations of claimed subject matter such settings may be embedded in a communications client such as an email client.

In some implementations of claimed subject matter, a pledge's communications client automatically process a passport, and the pledge may be notified that he or she has been introduced to an individual (e.g., a user) and may thus send that individual communications such as emails. In other implementations of claimed subject matter, a pledge may be required to examine a passport, and specify appropriate values of, for example, ring name, ring membership and/or role header keys when sending a communication to a user.

In some implementations of claimed subject a user may modify ring membership and/or a role of a person (e.g., pledge) being introduced to the user. In some implementations, such modifications may be sent as a new or modified passport receipt to a pledge. In yet other implementations, a user may ignore ring and/or role information provided by a pledge, and may, instead, use ring and/or role information specified in a contact database. In addition, a user may deny the introduction of a pledge thereby denying communicative access to the user's trusted relationship rings.

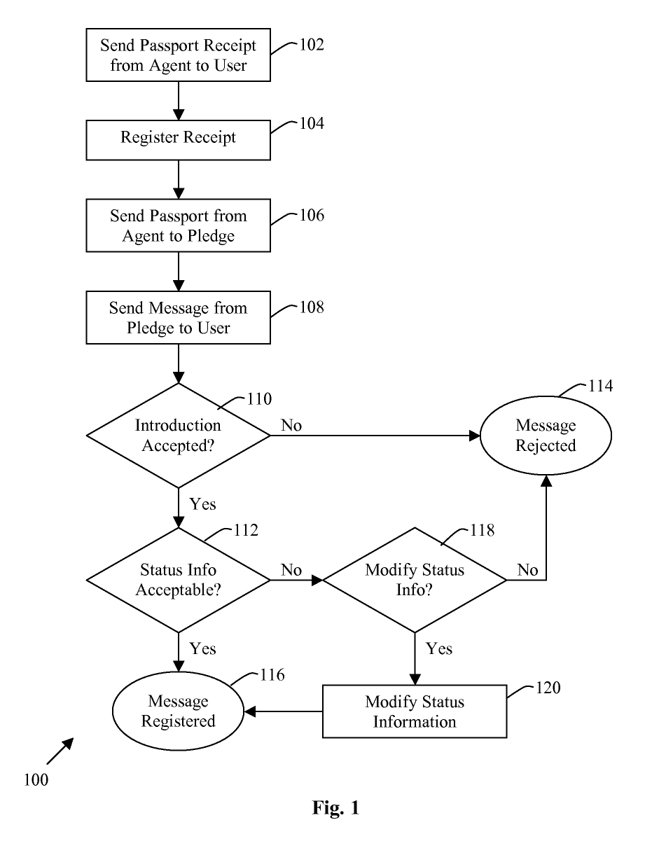

FIG. 1 illustrates an example process 100 in accordance with some implementations of claimed subject matter. While process 100 sets forth various acts and/or events, none of those acts and/or events should be viewed as limiting claimed subject, and, further, those skilled in the art will recognize that numerous alternatives to the acts and/or events shown in FIG. 1 may be practiced in accordance with claimed subject matter.

Process 100 may begin with the act 102 of sending a passport receipt from an agent to a user where the passport receipt may be associated with a passport as described above and where the passport may represent the introduction of a pledge to the user. As discussed above, a pledge may comprise a person seeking access to a user's relationship ring. As also discussed above, an agent may generate both a passport and passport receipt associated with the passport. In some implementations an agent may generate both a passport and passport receipt at the behest of a pledge. In act 106 the user may register the receipt. In some implementations of claimed subject matter act 106 may comprise the user registering the passport receipt for a limited period of time. In this context, registering a receipt may comprise having a passport manager place the receipt in a probationary area of a GUI as previously described although claimed subject matter is not limited in this regard.

Process 100 may continue with the agent sending the passport to the pledge [act 106] and the pledge sending a message, such as an email, to the user [act 108] in response to receiving the passport from the agent. As discussed above, the message sent from the pledge to the user may include “status information” indicating agent, ring and/or role information associated with the agent and/or pledge. In act 110 a determination is made as to whether the user has accepted the introduction of the pledge. In some implementations of claimed subject matter, a user may, after receiving and registering the passport receipt in acts 102/104 indicate that the user has refused to provide the pledge access to the relationship ring. The user may also do so after receipt of the message from the pledge in act 108.

If act 110 results in the user refusing the introduction, then the message may be rejected [act 114]. On the other hand, if the user accepts the introduction, then process 100 may proceed to a determination of whether the status information is acceptable to the user [act 112]. If the status information is acceptable to the user then the message may be registered [act 116]. In some implementations, registration of the message in act 116 may provide the pledge with communicative access to at least portions of the user's person-centric network. In some implementations, the status information associated with the message sent in act 108 may determine the extent of communicative access provided to the pledge.

If, on the other hand, the status information is not acceptable to the user then a determination may be made, in act 118, as to whether the user wants to modify the status information associated with the message. If the user chooses to not modify the status information in act 118 then the message may be rejected [act 114]. If, however, the user chooses to modify the status information in act 118 then process 100 may proceed to act 120 where the status information may be modified. In some implementations, act 120 may comprise the user modifying one or more of the agent, ring and/or role information associated with the agent and/or pledge. Process 100 may then proceed to act 116 where the message, now associated with modified status information, may be registered.

Claimed subject matter is, however, not limited to the example of process 100. Thus, for example, an alternative procedure for brining in a new contact may comprise simply adding that contact to a contact database. Further, while process 100 or other processes in accordance with claimed subject matter may be employed to control communicative access to a group of contacts, yet another alternative procedure also in accordance with claimed subject matter, may comprise employing a “spam” ring for unknown communications. In other words, a rule may be used to route communications received from unknown or undesirable senders to a spam ring. Subsequently, if unknown or undesirable senders on the spam ring are determined to be desirable or “good” contacts then those contacts may be promoted to higher level or trusted rings.

Claimed subject matter is not limited to specific communication types or technologies, thus, while the preceding description has focused on email communications, claimed subject matter can also encompass other media such as telephone messages that are managed along with email messages. For example, users may subscribe to voice mail services that forward voice mail to email: all techniques described herein can also be employed for such voice messages as well.

In addition, techniques in accordance with claimed subject matter may also be applied to pure voice devices, such as cell phones. Thus, for example, text messaging may be used for setting up passport and passport receipt exchanges. In addition, in some implementations, voice channel establishing protocols themselves may integrate a passport component as part of a link control protocol. Hence, for example, terminal devices, such as telephones and cell phones, may employ contact lists against the caller id or other link control information to control communicative access in accordance with claimed subject matter.

Further, in accordance with claimed subject matter, techniques described herein for introducing new contacts may also facilitate new contact introduction auditing. Thus, for example, if a newly introduced contact turns out to be undesirable then the party that introduced that new contact may become “suspect”, and his or her agent_enable property may be revoked or altered in response. Moreover, additional features in a communications client may further facilitate contact introduction auditing by maintaining a history of introductions that may be back traced when a bad introduction is subsequently made.

### Example System

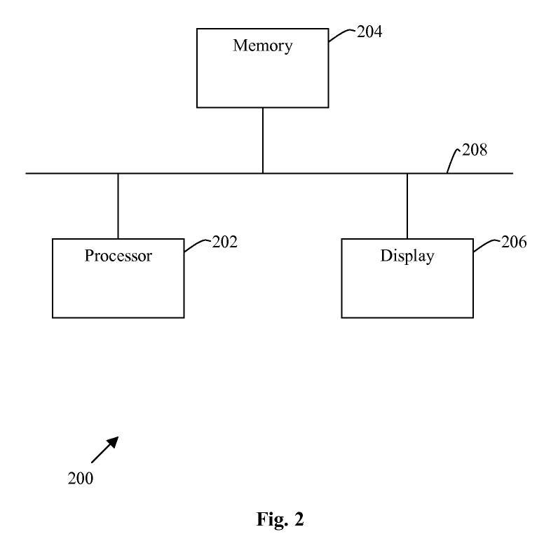

FIG. 2 is a block diagram of an example system 200. System 200 may be used to perform some or all of the various functions discussed above in connection with, for example, FIG. 1. System 200 may comprise any device or collection of devices, such as a terminal device, capable of facilitating communications including messages, electronic documents (e.g., Passports, etc.) etc. For example, system 200 may comprise a desktop computer, a laptop computer, a handheld computer, a smart and/or cellular telephone, a PDA, etc.

System 200 includes a processor 202 (e.g., Central Processing Unit (CPU)) such as a processor capable of providing and/or facilitating various functions including those described herein, memory 204 coupled to processor 202, and a display device 206 coupled to processor 202 and/or memory 204. Further, processor 202, display 206 and memory 204 may be coupled together by a communications pathway or bus 208. It will be recognized by those skilled in the art that a graphics processing unit (GPU), not shown in FIG. 2, may be coupled to processor 202 and/or may be internal to processor 202, and may be coupled to display device 206 in order to provide display device 206 with displayable information. Such displayable information may be presented on display device 206 in the form of a GUI where that GUI may be capable of providing visual representations of r-smart person-centric networks, electronic documents such as passports etc. in accordance with some implementations of claimed subject matter.

In accordance with some implementations of claimed subject matter, processor 202 may include logic to facilitate, build, generate and/or operate on internal representations such as list structures, data structures and/or arrays used to define r-smart person-centric networks. Further, in accordance with some implementations of claimed subject matter, memory 204 may act in conjunction with processor 202 to store or hold at least portions of such internal representations.

Those skilled in the art will recognize that memory 204 and/or processor 202 may be further coupled to one or more controllers, not shown in FIG. 2, that may facilitate the communication of information, such as information specifying a GUI, between processor 202 and/or memory 204 and/or display 206. Further, memory 204, which may be any device or collection of devices that provide for the storage of data. For example, memory 204 may comprise a hard disk drive (HDD) or some other magnetic storage media or may comprise optical storage technology. Alternatively, memory 204 may comprise memory internal to processor 202, and/or may comprise one or more discrete memory devices external to processor 202. Further, memory 204 may comprise any other memory technology (e.g., random access memory (RAM), flash memory, etc.). In accordance with some implementations of claimed subject matter, memory 204 may, at least temporarily, store or hold information capable of providing visual representations of r-smart person-centric networks and/or indicators (e.g., icons) representative of, for example, contacts belonging to person-centric networks. Such information may comprise, for example, information specifying at least portions of a GUI capable of providing visual representations of r-smart person-centric networks and capable of being displayed on display device 206.

Display device 206, which may comprise any type of display device such as a Liquid Crystal Display (LCD) display, a polymer-based display, an electroluminescent display, a Plasma Display Panel (PDP), or a Cathode Ray Tube (CRT) display, to name a few of the more prominent examples. Although example system 200 is shown with a particular configuration of components, other implementations are possible using any of a wide range of configurations. Further, those skilled in the art will recognize that system 200 may include many additional components such as communications buses etc., not particularly germane to claimed subject matter, that have not been illustrated in FIG. 2 in the interests of not obscuring claimed subject matter.

While particular implementations have just been described, claimed subject matter is not limited in scope to one or more particular implementations. For example, some implementations may be in hardware, such as employed to operate on a device or combination of devices, for example, whereas other implementations may be in software. Further, some implementations may be employed in firmware, or as any combination of hardware, software, and/or firmware, for example. Likewise, although claimed subject matter is not limited in scope in this respect, some implementations may comprise one or more articles, such as a storage medium or storage media. This storage media, such as, one or more CD-ROMs, computer disks, flash memory, or the like, for example, may have instructions stored thereon, that, when executed by a system, such as a computer system, computing platform, or other system, for example, may result in execution of an implementation of a method in accordance with claimed subject matter, such as one of the implementations previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations. Also, as used herein, the article “a” includes one or more items. Moreover, when terms or phrases such as “coupled” or “responsive” or “in response to” or “in communication with” are used herein or in the claims that follow, these terms should be interpreted broadly. For example, the phrase “coupled to” may refer to being communicatively, electrically and/or operatively coupled as appropriate for the context in which the phrase is used.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now, or in the future, occur to those skilled in the art. It is, therefore, to be understood that the appended claims are intended to cover all such modifications and/or changes as fall within the true spirit of claimed subject matter.

What is claimed:

1. A method comprising:
sending a first communication to a user of a communications client, the first communication indicating that a person seeks to send a second communication to the user; and
sending a third communication to the person, the third communication indicating that the person may send the second communication to the user.

2. The method of claim 1, wherein the communications client is adapted to support an r-smart network.

3. The method of claim 1, wherein the communications client is adapted to support relationship rings.

4. The method of claim 1, wherein a second person sends the first communication to the user, and wherein the third communication includes at least one of an identifier of the second person, a relationship ring name, and/or a role associated with the second person.

5. The method of claim 1, further comprising:
preventing the second person from sending the first communication.

6. The method of claim 1, wherein a second person sends the first communication to the user, and wherein the second communication includes at least one of an identifier of the second person, a relationship ring name, and/or a role associated with the second person.

7. The method of claim 6, further comprising:
rejecting the second communication if the user does not accept the at least one of an identifier of the second person, a relationship ring name, and/or a role.

8. The method of claim 6, further comprising:
registering the second communication if the user accepts the at least one of an identifier of the second person, a relationship ring name, and/or a role.

9. The method of claim 6, further comprising:
modifying the identifier of the second person, the relationship ring name, and/or the role.

10. The method of claim 1, further comprising:
generating an entry for the person on a contact list in response to the first communication.

11. The method of claim 10, wherein generating an entry comprises displayed the entry in a graphical user interface (GUI).

12. The method of claim 10, wherein generating an entry comprises generating an entry for a limited period of time.

13. The method of claim 1, wherein the first communication comprises a human comprehensible introductory note.

14. The method of claim 1, wherein a communications client associated with the person processes the third communication and notifies the person that they may send the second communication to the user.

15. The method of claim 1, wherein the second communication comprises an email.

16. The method of claim 1, further comprising:
rejecting the second communication if a privilege associated with the second communication has expired.

17. An article comprising: a storage medium having stored therein instructions that, if executed, result in:
sending a first communication to a user of a communications client, the first communication indicating that a person seeks to send a second communication to the user; and
sending a third communication to the person, the third communication indicating that the person may send the second communication to the user.

18. The article of claim 17, wherein the communications client is adapted to support an r-smart network.

19. The article of claim 17, wherein the communications client is adapted to support relationship rings.

20. The article of claim 17, wherein a second person sends the first communication to the user, and wherein the third communication includes at least one of an identifier of the second person, a relationship ring name, and/or a role associated with the second person.

21. The article of claim 17, the storage medium having stored therein instructions that, if executed, further result in:
preventing the second person from sending the first communication.

22. The article of claim 17, wherein a second person sends the first communication to the user, and wherein the second communication includes at least one of an identifier of the second person, a relationship ring name, and/or a role associated with the second person.

23. The article of claim 22, the storage medium having stored therein instructions that, if executed, further result in:
rejecting the second communication if the user does not accept the at least one of an identifier of the second person, a relationship ring name, and/or a role.

24. The article of claim 22, the storage medium having stored therein instructions that, if executed, further result in:
registering the second communication if the user accepts the at least one of an identifier of the second person, a relationship ring name, and/or a role.

25. The article of claim 22, the storage medium having stored therein instructions that, if executed, further result in:
modifying the identifier of the second person, the relationship ring name, and/or the role.

26. The article of claim 17, the storage medium having stored therein instructions that, if executed, further result in:
generating an entry for the person on a contact list in response to the first communication.

27. The article of claim 26, wherein generating an entry comprises displayed the entry in a graphical user interface (GUI).

28. The article of claim 26, wherein generating an entry comprises generating an entry for a limited period of time.

29. The article of claim 17, wherein the first communication comprises a human comprehensible introductory note.

30. The article of claim 17, wherein a communications client associated with the person processes the third communication and notifies the person that they may send the second communication to the user.

31. The article of claim 17, wherein the second communication comprises an email.

32. The article of claim 17, the storage medium having stored therein instructions that, if executed, further result in:
rejecting the second communication if a privilege associated with the second communication has expired.

33. An apparatus, comprising:
a terminal device having logic adapted to send a first communication to a user of a communications client, the first communication indicating that a person seeks to send a second communication to the user; and adapted to send a third communication to the person, the third communication indicating that the person may send the second communication to the user.

34. The apparatus of claim 33, wherein the communications client is adapted to support r-smart networks and/or wherein the communications client is adapted to support relationship rings.

35. The apparatus of claim 33, wherein the first communication comprises a human comprehensible introductory note.

36. The apparatus of claim 33, wherein a second person sends the first communication to the user, and wherein the third communication includes at least one of an identifier of the second person, a relationship ring name, and/or a role associated with the second person.

37. The apparatus of claim 33, wherein a second person sends the first communication to the user, and wherein the second communication includes at least one of an identifier of the second person, a relationship ring name, and/or a role associated with the second person.

38. The apparatus of claim 33, wherein the terminal device comprises one of a computer, a telephone, and a personal digital assistant.

39. A system, comprising:
a processor;
storage coupled to the processor; and
a display coupled to the processor;
wherein the processor is adapted to send a first communication to a user of a communications client, the first communication indicating that a person seeks to send a second communication to the user; and adapted to send a third communication to the person, the third communication indicating that the person may send the second communication to the user.

40. The system of claim 39, wherein the communications client is adapted to support r-smart networks and/or wherein the communications client is adapted to support relationship rings.

41. The system of claim 39, wherein the first communication comprises a human comprehensible introductory note.

42. The system of claim 39, wherein a second person sends the first communication to the user, and wherein the third communication includes at least one of an identifier of the second person, a relationship ring name, and/or a role associated with the second person.

43. The system of claim 39, wherein a second person sends the first communication to the user, and wherein the second communication includes at least one of an identifier of the second person, a relationship ring name, and/or a role associated with the second person.

44. The system of claim 39, wherein the processor is contained in one of a computer, a telephone, and a personal digital assistant.
